(19) United States
(12) Patent Application Publication
(10) Pub. No.: US 2010/0001646 A1
(43) Pub. Date: Jan. 7, 2010

(54) DEVICE CAPABLE OF GENERATING ELECTRICITY, AND METHOD OF GENERATING ELECTRICITY

(76) Inventors: Chien-An YU, Beitou District (TW); Pei-Chen Chen, East District (TW)

Correspondence Address: MERCHANT & GOULD PC, P.O. BOX 2903, MINNEAPOLIS, MN, 55402-0903, US

(21) Appl. No.: 12/487,553

(22) Filed: Jun. 18, 2009

(30) Foreign Application Priority Data
Jul. 2, 2008 (TW) 097124841
Dec. 19, 2008 (TW) 097149696

(51) Int. Cl. B60Q 1/04; H02N 2/18; H05B 37/02

(52) U.S. Cl. 315/82; 310/339; 315/302

(57) ABSTRACT

A device capable of generating electricity includes a rotating unit and a piezoelectric component. The rotating unit is rotatable about a rotation axis and includes a plurality of strikers that are disposed at angularly spaced apart positions relative to the rotation axis and that define a plurality of voids, each of which is located between an adjacent pair of the strikers. The piezoelectric component has a portion that extends into one of the voids. Rotation of the rotating unit results in the strikers striking the portion of the piezoelectric component intermittently, and causes the piezoelectric component to deform, exhibit a direct piezoelectric effect and generate electricity.

### CROSS-REFERENCE TO RELATED APPLICATIONS

This application claims priority of Taiwanese Application No. 097124841, filed on Jul. 2, 2008, and Taiwanese Application No. 097149696, filed on Dec. 19, 2008.

### BACKGROUND OF THE INVENTION

1. Field of the Invention

The present invention relates to a device capable of generating electricity, more particularly to a device capable of generating electricity through deformation of a piezoelectric material to convert mechanical energy to electricity.

2. Description of the Related Art

Referring to FIGS. 1 to 3, Taiwanese Patent No. TW288207 discloses a wind-type power generating device 700 for a vehicle. Air flows into the wind-type power generating device 700 through a wind inlet 711 and out of the wind-type power generating device 700 through a wind outlet 712 for driving rotation of a fan component 730. A rotating component 741 of a rotary-to-linear converting mechanism 740 connected to an axial part 731 of the fan component 730 rotates around the axial part 731 to drive rotation (indicated by an arrow in FIG. 3) of one end of a crank 742 connected to the rotating component 741. Further, the rotation of the crank 742 drives reciprocating motion of a drive part 751 of a linear alternator 750 connected to the other end of the crank 742 to generate electricity.

FIG. 4 shows an illuminating device 800 constructed from a wind-type power generating mechanism and an illuminating component, such as a light emitting diode lamp. The illuminating device 800 can be applied to a bicycle as an example. When wind blows in a direction indicated by an arrow in FIG. 4 toward a fan component 810 to drive rotation thereof, an induction coil 820 disposed around a shaft 811 of the fan component 810 senses variations in magnetic flux, generates electricity, and outputs the electricity to a circuit board module 830. The circuit board 830 module processes the electricity from the induction coil 820, and provides the processed electricity to light emitting diode lamps 840 for illumination.

### SUMMARY OF THE INVENTION

An object of the present invention is to provide a device capable of generating electricity using piezoelectric material.

Accordingly, a device capable of generating electricity of the present invention comprises a rotating unit and at least one piezoelectric component. The rotating unit is rotatable about a rotation axis, and includes a plurality of strikers that are disposed at angularly spaced apart positions relative to the rotation axis and that define a plurality of voids, each of which is located between an adjacent pair of the strikers. The piezoelectric component has a portion that extends into one of the voids of the rotating unit. Rotation of the rotating unit about the rotation axis results in the strikers striking the portion of the piezoelectric component intermittently to thereby cause the piezoelectric component to deform, exhibit a direct piezoelectric effect and generate electricity.

Another object of the present invention is to provide a method of generating electricity using piezoelectric material.

According to another aspect of the present invention, a method of generating electricity comprises the steps of:

a) providing a rotating unit that is rotatable about a rotation axis and that includes a plurality of strikers disposed at angularly spaced apart positions relative to the rotation axis, the strikers defining a plurality of voids, each of which is located between an adjacent pair of the strikers;

b) extending a portion of a piezoelectric component into one of the voids of the rotating unit; and

c) causing the rotating unit to rotate about the rotation axis, thereby resulting in the strikers striking the portion of the piezoelectric unit intermittently such that the piezoelectric component deforms, exhibits a direct piezoelectric effect and generates electricity.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional wind-type power generating device for a vehicle;

FIG. 2 is a schematic partly sectional view taken along line II-II in FIG. 1;

FIG. 3 is a schematic partly sectional view taken along line III-III in FIG. 1;

FIG. 4 is a schematic partly sectional view of a conventional illuminating device capable of generating electricity using wind force;

FIG. 5 is a schematic view illustrating a bicycle that incorporates a first preferred embodiment of a device capable of generating electricity according to the present invention;

FIG. 6 is a schematic perspective view of the first preferred embodiment;

FIGS. 7 and 8 are schematic diagrams to illustrate generation of electricity by a piezoelectric plate when subjected to a mechanical force;

FIG. 9 is a schematic diagram illustrating a plurality of the piezoelectric plates interconnected electrically in a parallel connection;

FIG. 10 is a schematic diagram illustrating a plurality of the piezoelectric plates interconnected electrically in a series connection;

FIG. 11 is a side view of FIG. 10 for illustrating an output voltage of the piezoelectric plates;

FIG. 12 is a schematic block diagram of the device of the first preferred embodiment; and

FIG. 13 is a schematic view of a bicycle that incorporates a second preferred embodiment of the device capable of generating electricity according to the present invention.

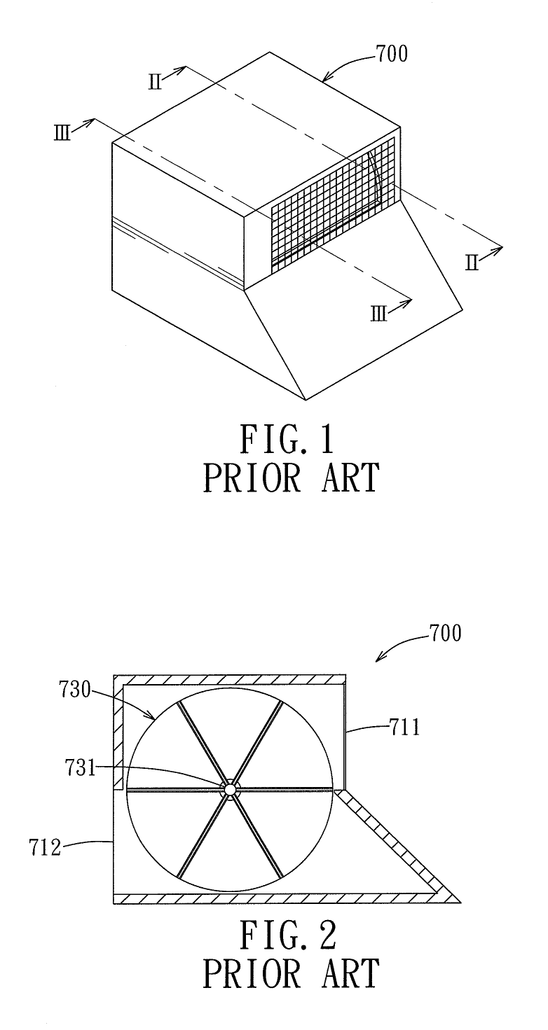

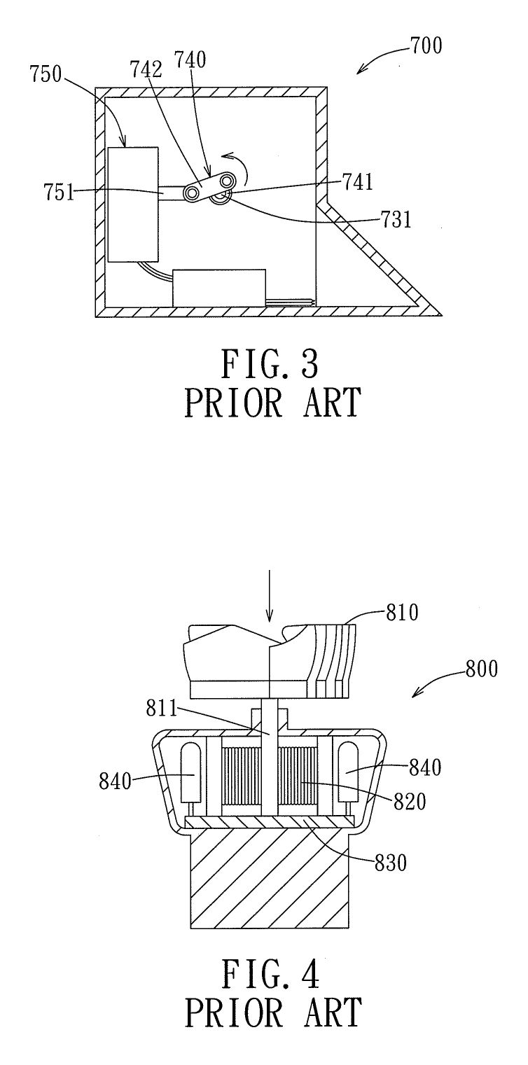

### DETAILED DESCRIPTION OF THE PREFERRED EMBODIMENTS

Before the present invention is described in greater detail, it should be noted that like elements are denoted by the same reference numerals throughout the disclosure.

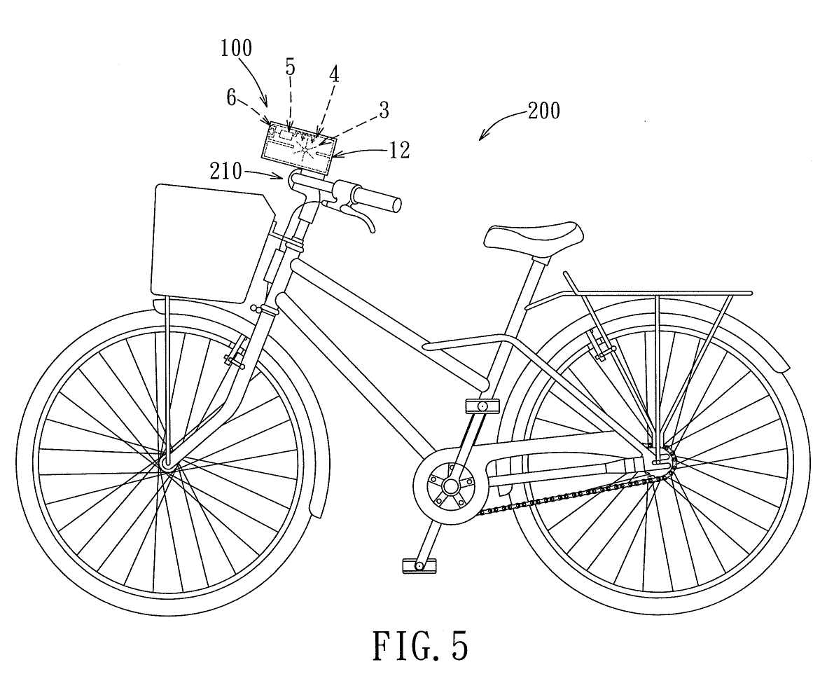

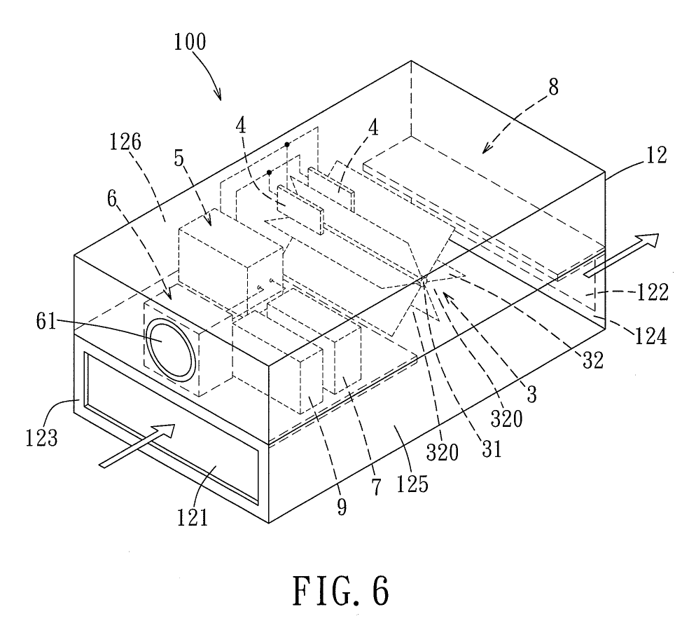

Referring to FIGS. 5 and 6, the first preferred embodiment of a device 100 capable of generating electricity of the present invention is disposed on a handlebar 210 of a bicycle 200 for illumination. The device 100 includes a casing 12, a plurality of piezoelectric components 4, a power supply unit 5, a light emitting unit 6, an energy storage unit 7, a switch unit 9, and a rotating unit.

The casing 12 defines an accommodation space 8, and includes a front sidewall 123 formed with a wind inlet 121, and a rear sidewall 124 that is opposite to the front sidewall 123 and that is formed with a wind outlet 122. In practice, the front sidewall 123 can be also formed with a plurality of the wind inlets 121, and the rear sidewall 124 can be also formed with a plurality of the wind outlets 122. The wind inlet 121 and the wind outlet 122 are in fluid communication with the accommodation space 8 and respectively permit air to flow into and out of the accommodation space 8 in a direction indicated by arrows in FIG. 6. The casing 12 further includes a left sidewall 125 and a right sidewall 126.

The rotating unit is rotatable about a rotation axis and includes a plurality of strikers that are disposed at angularly spaced apart positions relative to the rotation axis and that define a plurality of voids. Each of the voids is located between an adjacent pair of the strikers. In this embodiment, the rotating unit is in a form of a fan component 3 received in the accommodation space 8 and having an axial part 31 that extends along the rotation axis and a plurality of blades 32 that are connected to the axial part 31 and that serve as the strikers. The blades 32 define a plurality of voids 320, each of which is located between an adjacent pair of the blades 32. When air flows into and out of the accommodation space 8 through the wind inlet 121 and the wind outlet 122, the fan component 3 is driven to rotate by the air flowing into the accommodation space 8. In this embodiment, the axial part 31 of the rotating unit 3 is disposed perpendicular to the airflow path through the wind inlet 121 and the wind outlet 122 of the casing 12, but is not limited to the disclosure herein.

The piezoelectric components 4 are disposed on the right sidewall 126 of the casing 12. Each of the piezoelectric components 4 has a portion extending into one of the voids 320 of the fan component 3. Rotation of the fan component 3 about the rotation axis results in the blades 32 striking the portion of each of the piezoelectric components 4 intermittently, thereby causing the piezoelectric components 4 to deform, exhibit a direct piezoelectric effect and generate electricity. Each of the piezoelectric components 4 is plate-shaped, extends parallel to the rotation axis, and includes a piezoelectric plate or a stack of the piezoelectric plates that are interconnected electrically in a series connection, or a parallel connection. The power supply unit 5 is electrically connected to one end of each of the piezoelectric components 4 adjacent to the casing 12.

The electrical interconnection between the power supply unit 5 and the piezoelectric components 4 is different when each of the piezoelectric components 4 includes only one piezoelectric plate or includes a plurality of the piezoelectric plates. Details of the electrical interconnection between the power supply unit 5 and the piezoelectric components 4 are described in the following paragraphs.

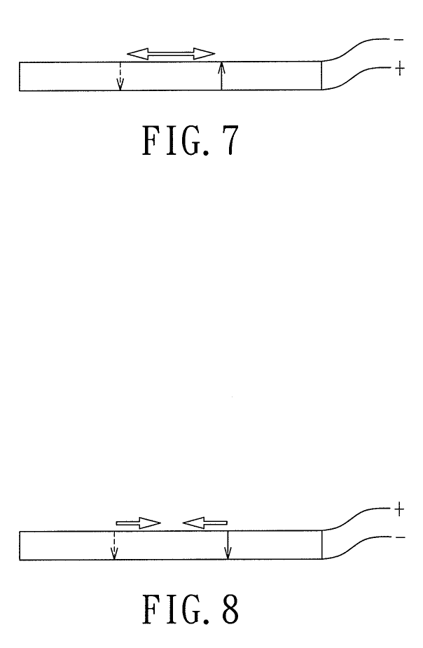

When each of the piezoelectric components 4 includes only one piezoelectric plate, referring to FIG. 7, the piezoelectric plate generates an internal electric field in the direction indicated by the solid arrow opposite to a polarization direction of the piezoelectric plate indicated by the dashed arrow while the pulling forces are applied to the piezoelectric plate. In this case, the internal electric field results in a bottom surface of the piezoelectric plate serving as a positive electrode and a top surface of the piezoelectric plate serving as a negative electrode. Referring to FIG. 8, the piezoelectric plate generates an internal electric field in the direction indicated by the solid arrow same as the polarization direction of the piezoelectric plate indicated by the dashed arrow while the compressive forces are applied to the piezoelectric plate. In this case, the internal electric field results in the bottom surface of the piezoelectric plate serving as a negative electrode, and the top surface of the piezoelectric plate serving as a positive electrode. In both instances, the magnitude of the internal electric field is proportional to the force.

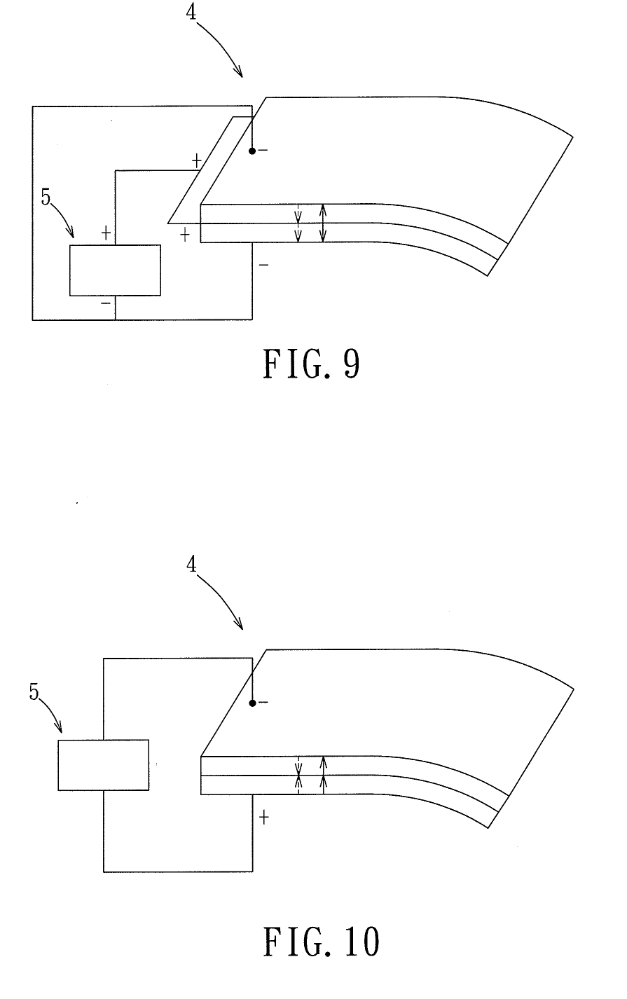

Regarding the piezoelectric components 4 each of which includes a stack of two piezoelectric plates as an example, FIG. 9 illustrates the two piezoelectric plates electrically interconnected in a manner that a polarization direction (indicated by a downward dashed arrow) of each of the piezoelectric plates is the same. When the stack of the piezoelectric plates is bent downwardly, an upper one of the piezoelectric plates is extended and generates an internal electric field in the direction indicated by an upward solid arrow opposite to the polarization direction thereof, and a lower one of the piezoelectric plates is compressed and generates an internal electric field in the direction indicated by a downward solid arrow same as the polarization direction thereof. The top surface of the upper one of the piezoelectric plates and the bottom surface of the lower one of the piezoelectric plates are electrically connected and serve as negative electrodes, and the bottom surface of the upper one of the piezoelectric plates and the top surface of the lower one of the piezoelectric plates are adjacent to each other and serve as positive electrodes, i.e., the piezoelectric plates are electrically interconnected in a parallel connection.

Moreover, the two piezoelectric plates shown in FIG. 10 are electrically interconnected in a manner that a polarization direction of the upper one of the piezoelectric plates is a downward direction indicated by a dashed arrow, and a polarization direction of the lower one of the piezoelectric plates is an upward direction indicated by a dashed arrow. When the stack of the piezoelectric plates is bent downwardly, the upper one of the piezoelectric plates is extended and generates an internal electric field in the direction indicated by an upward solid arrow opposite to the polarization direction thereof, and the lower one of the piezoelectric plates is compressed and generates an internal electric field in the direction indicated by an upward solid arrow same as the polarization direction thereof. The bottom surfaces of both the piezoelectric plates serve as positive electrodes, and the top surfaces of both of the piezoelectric plates serve as negative electrodes, i.e., the piezoelectric plates are electrically interconnected in a series connection.

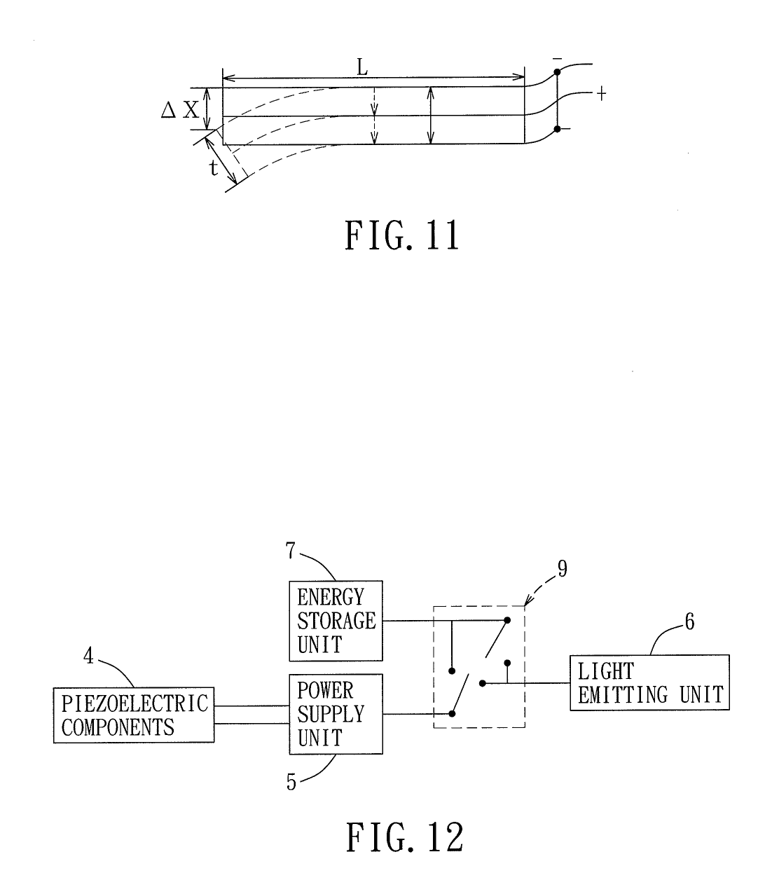

An output voltage of the stack of the piezoelectric plates shown in FIG. 9 is illustrated with reference to FIG. 11. When the stack of the piezoelectric plates with a length (L) of 2 cm and a thickness (t) of 9 μm is bent downwardly by a distance (ΔX) of 0.426 mm, the output voltage of the stack of the piezoelectric plates is about 5V obtained based upon a known equation. Therefore, the output voltage is substantially sufficient for driving operation of the light emitting unit 6.

By the above-mentioned configuration, when air flows into and out of the accommodation space 8 through the wind inlet 121 and the wind outlet 122, the fan component 3 is driven to rotate by the air flowing into the accommodation space 8. Further, the rotation of the fan component 3 results in the blades 32 striking each of the piezoelectric components 4 intermittently, and causes the piezoelectric components 4 to deform. Therefore, the piezoelectric components 4 exhibit a direct piezoelectric effect and generate electricity provided to the power supply unit 5.

In principle, a number of the piezoelectric plates of each of the piezoelectric components 4 should not result in obstruction of the rotation of the fan component 3. Preferably, the piezoelectric plates of the piezoelectric components 4 can be made of a material with relatively greater resiliency, such as polyvinylidene difluoride (PVDF) having an elastic modulus of 1.37×10³ Mpa (at 22.8° C.) and elongation in the range from 25% to 500%, zinc oxide, or a combination thereof. The power supply unit 5 is capable of processing the electricity generated by the piezoelectric components 4 to generate a voltage output. The light emitting unit 6 includes a light emitting diode (LED) lamp 61 and is disposed on the front sidewall 123 of the casing 12 as shown in FIG. 6. The energy storage unit 7 is used for storing electric power and is capable of outputting an electric power signal. In this embodiment, the power supply unit 5, the energy storage unit 7, and the switch unit 9 are disposed in the accommodation space 8 between the light emitting unit 6 and the fan component 3.

Referring to FIG. 12, each of the piezoelectric components 4 is electrically connected to the power supply unit 5. The power supply unit 5 processes the electricity generated by the piezoelectric components 4, and generates the voltage output. The switch unit 9 is electrically connected to the power supply unit 5 and the energy storage unit 7, and is operable to select the power supply unit 5 to output the voltage output or the energy storage unit 7 to output the electric power signal. The light emitting unit 6 is electrically connected to the switch unit 9, and the LED lamp 61 of the light emitting unit 6 is operable to emit light upon receiving the voltage output from the power supply unit 5 or the electric power signal from the energy storage unit 7. If there is no requirement of light, such as during daytime, the switch unit 9 is further operable to cut off the electrical connection between the light emitting unit 6 and both of the power supply unit 5 and the energy storage unit 7 to stop providing the voltage output and the electric power signal to the light emitting unit 6, and is operable to electrically interconnect the power supply unit 5 and the energy storage unit 7 for charging the energy storage unit 7.

The energy storage unit 7 can be omitted in other embodiments of the invention. Moreover, the light emitting unit 6 can be omitted, and the device 100 of the invention can be used as an energy storing device in further embodiments of the invention. The light emitting unit 6 may even be replaced by other electric devices. Additionally, aside from disposal on the bicycle 200, the device 100 can be disposed on other vehicles or a helmet.

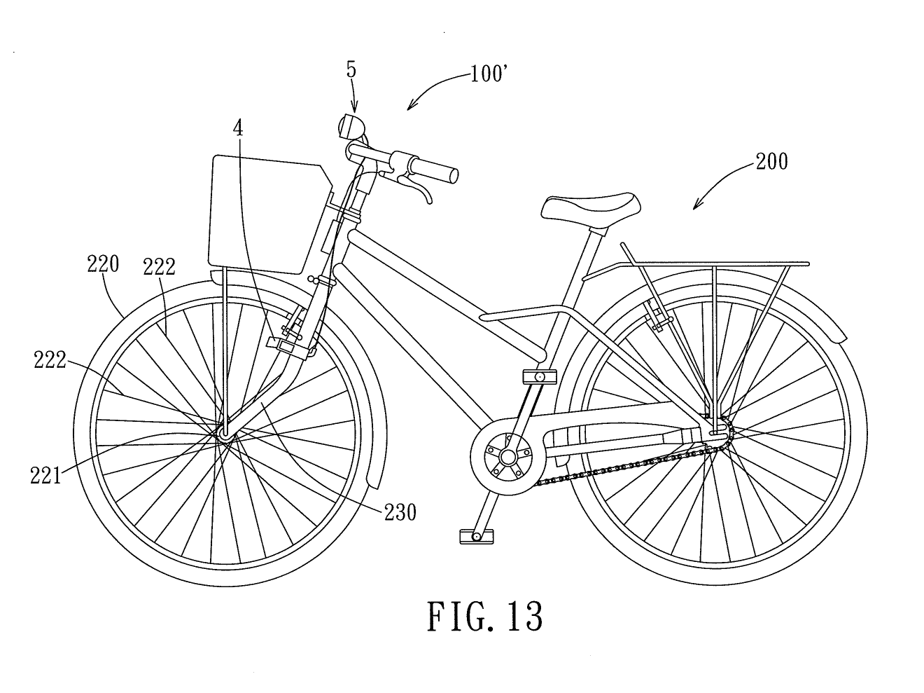

Referring to FIG. 13, the second preferred embodiment of the device 100′ of the invention does not generate electricity by air flowing into the accommodation space 8. The device 100′ is similar to the device 100 of the first preferred embodiment, and is also disposed on the bicycle 200. The difference resides in that the casing 12 is omitted and the rotating unit is in a form of a bicycle wheel 220 replacing the fan component 3 of the first preferred embodiment. The bicycle wheel 220 is mounted rotatably to a bicycle fork 230, is rotatable about a wheel axle 221, and has a plurality of spokes 222 serving as the strikers. The spokes 222 are disposed at angularly spaced apart positions relative to the wheel axle 221 and define a plurality of voids, each of which is located between an adjacent pair of the spokes 222. The piezoelectric component 4 is mounted to the bicycle fork 230, and has a portion that extends into one of the voids of the bicycle wheel 220. The piezoelectric component 4 is plate-shaped, and extends parallel to the wheel axle 221.

When the bicycle wheel 220 of the bicycle 200 rotates, the spokes 222 rotate and strike the piezoelectric component 4. Therefore, the piezoelectric component 4 deforms, exhibits a direct piezoelectric effect and generates electricity that is provided to the power supply unit 5. Since the principle of generating electricity is the same as that in the first preferred embodiment, details thereof will be omitted herein for the sake of brevity. The light emitting unit, the energy storage unit, and the switch unit are disposed in the power supply unit 5 and form a unitary structure. In this embodiment, a rider (not shown) of the bicycle 200 rides the bicycle 200 to result in the device 100′ generating electricity. In practice, the device 100′ can be disposed on an exercise bike or a motorcycle having a wheel and a wheel axle to generate electricity and to provide electricity to an instrument panel of the motorcycle or a display unit of the exercise bike provided with the device 100′.

The preferred embodiment of a method of generating electricity will now be described in the succeeding paragraphs.

First, a rotating unit rotatable about a rotation axis is provided. The rotating unit includes a plurality of strikers disposed at angularly spaced apart positions relative to the rotation axis. The strikers define a plurality of voids, each of which is located between an adjacent pair of the strikers. The rotating unit can be in a form of the fan component 3 shown in FIG. 6 or the bicycle wheel 220 shown in FIG. 13.

Then, a portion of a piezoelectric component is extended into one of the voids of the rotating unit.

Finally, the rotating unit is caused to rotate about the rotation axis to thereby result in the strikers striking the portion of the piezoelectric unit intermittently such that the piezoelectric component deforms, exhibits a direct piezoelectric effect and generates electricity. In practice, the rotating unit can be driven by wind (e.g., the first preferred embodiment) or by mechanical transmission (e.g., the second preferred embodiment) to rotate about the rotation axis.

In sum, the device 100, 100′ of the present invention generates electricity provided to an electrical load (e.g., the light emitting unit 6) by virtue of the blades 32 or the spokes 222 striking the piezoelectric components 4 intermittently, causing the piezoelectric components 4 to deform, exhibit a direct piezoelectric effect and generate electricity. Therefore, the objects of the present invention can be positively achieved.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A device capable of generating electricity, comprising:
a rotating unit rotatable about a rotation axis and including a plurality of strikers that are disposed at angularly spaced apart positions relative to the rotation axis and that define a plurality of voids, each of which is located between an adjacent pair of said strikers; and
at least one piezoelectric component having a portion that extends into one of said voids of said rotating unit, wherein rotation of said rotating unit about the rotation axis results in said strikers striking said portion of said piezoelectric component intermittently, causing said piezoelectric component to deform, exhibit a direct piezoelectric effect and generate electricity.

2. The device as claimed in claim 1, wherein said rotating unit is in a form of a fan component having an axial part that extends along the rotation axis and a plurality of blades that are connected to said axial part and that serve as said strikers.

3. The device as claimed in claim 2, wherein said piezoelectric component is plate-shaped, and each of said piezoelectric component and said blades of said rotating unit extends parallel to the rotation axis.

4. The device as claimed in claim 2, further comprising a casing, said rotating unit and said piezoelectric component being disposed in said casing.

5. The device as claimed in claim 4, wherein said casing defines an accommodation space within which said rotating unit and said piezoelectric component are disposed, and includes a front sidewall formed with a wind inlet, and a rear sidewall that is opposite to said front sidewall and that is formed with a wind outlet, said wind inlet and said wind outlet being in fluid communication with said accommodation space and respectively permitting air to flow into and out of said accommodation space for driving rotation of said rotating unit.

6. The device as claimed in claim 5, wherein said axial part of said rotating unit is disposed perpendicular to an airflow path through said wind inlet and said wind outlet of said casing.

7. The device as claimed in claim 5, wherein said casing further includes a right sidewall and a left sidewall opposite to said right sidewall, and both of said rotating unit and said piezoelectric component are disposed on one of said front, rear, right, and left sidewalls.

8. The device as claimed in claim 1, wherein said piezoelectric component includes at least one piezoelectric plate.

9. The device as claimed in claim 8, wherein said piezoelectric component includes a stack of said piezoelectric plates that are interconnected electrically in one of a series connection and a parallel connection.

10. The device as claimed in claim 1, further comprising a power supply unit electrically coupled to said piezoelectric component and capable of processing the electricity generated by said piezoelectric component to generate a voltage output.

11. The device as claimed in claim 10, further comprising an electrical load electrically coupled to said power supply unit.

12. The device as claimed in claim 11, wherein said electrical load is a light emitting unit.

13. The device as claimed in claim 11, further comprising an energy storage unit electrically coupled to said power supply unit.

14. The device as claimed in claim 1, wherein said piezoelectric component is made of a material selected from the group consisting of polyvinylidene difluoride, zinc oxide, and a combination thereof.

15. The device as claimed in claim 1, wherein said rotating unit is in a form of a bicycle wheel that is adapted to be mounted rotatably to a bicycle fork and that has a plurality of spokes serving as said strikers, said piezoelectric component being adapted to be mounted to the bicycle fork.

16. A method of generating electricity, comprising the steps of:
a) providing a rotating unit that is rotatable about a rotation axis and that includes a plurality of strikers disposed at angularly spaced apart positions relative to the rotation axis, the strikers defining a plurality of voids, each of which is located between an adjacent pair of the strikers;
b) extending a portion of a piezoelectric component into one of the voids of the rotating unit; and
c) causing the rotating unit to rotate about the rotation axis, thereby resulting in the strikers striking the portion of the piezoelectric unit intermittently such that the piezoelectric component deforms, exhibits a direct piezoelectric effect and generates electricity.

17. The method as claimed in claim 16, wherein, in step c), the rotating unit is driven by wind to rotate about the rotation axis.

18. The method as claimed in claim 16, wherein, in step c), the rotating unit is driven by mechanical transmission to rotate about the rotation axis.

19. The method as claimed in claim 16, wherein the piezoelectric component includes at least one piezoelectric plate.

20. The method as claimed in claim 19, wherein the piezoelectric component includes a stack of the piezoelectric plates that are interconnected electrically in one of a series connection and a parallel connection.

21. The method as claimed in claim 16, wherein the piezoelectric component is made of a material selected from the group consisting of polyvinylidene fluoride, zinc oxide, and a combination thereof.
